(19) United States
(12) Patent Application Publication
(10) Pub. No.: US 2002/0187263 A1
(43) Pub. Date: Dec. 12, 2002

(54) Method of utilizing ribonucleic acid as markers for product anti-counterfeit labeling and verification

(76) Inventors: Jue-Jei Sheu, Tu-Chang City (TW); Lin-Lin Chen, Tu-Chang City (TW); Emma Chen, Tu-Chang City (TW); Benjamin Liang, Tu-Chang City (TW)

Correspondence Address: LAW OFFICE OF LIAUH & ASSOCIATES, 4224 WAIALAE AVENUE, SUITE 5-388, HONOLULU, HI, 96816-5307, US

(21) Appl. No.: 09/832,048

(22) Filed: Apr. 9, 2001

(51) Int. Cl. B05D 5/00

(52) U.S. Cl. 427/256

(57) ABSTRACT

This invention features a method of labeling objects for anti-counterfeit purpose, especially refers to a method employing ribonucleic acid for product anti-counterfeit labeling and authenticity verification by PCR method. The procedure involves label objects with medium which contains ribonucleic acid. For verification of authenticity, the medium is removed and extracted for ribonucleic acid which is then amplified by PCR method for comparison.

### BACKGROUND OF INVENTION

One of the problems that frequently encountered in product manufacturing and marketing is imitation and counterfeit. Imitations and counterfeits mimic the shape and brand of authenticity and take advantages of its images to make profits; Most of the time imitations and counterfeits are look alike with poor quality; there are also some with near-authenticity quality, but due to lacking advertising and marketing cost, they can be sold in lower price to rob the market share. In addition, valuable items such as painting, jewelry and souvenirs and items with monetary values such as credit card, checkbook and stocks also constantly face the problem of counterfeiting. Problems like these not only ruin the reputation of the authentic products, affecting sales, can further jeaperdize the monetary order and invention creativity. Therefore, there is a need and necessity to counter imitations and counterfeits.

In addition to utilizing unique design and quality to appear to customers, there are also some extra measures to realize the anti-counterfeit purpose, such as the magnetic tape on the checkbook, the laser holograph on the credit card, and special marks which can only be seen under light with certain wavelength (U.S. Pat. No. 5,599,578). There are also methods using markers encapsulated in microspheres (U.S. Pat. No. 6,030,657), utilizing a person's fingerprints (U.S. Pat. No. 5,360,628), adding antigen to the object and detected with antibody (U.S. Pat. No. 5,429,952, U.S. Pat. No. 5,942,444). Methods mentioned above are all meant to establish a technical or methodic barrier to prevent imitations and counterfeits. However, these known methods provide the protection of technical barrier which can be easily duplicated by person with the same technical skills. This invention is meant to provide a more specific anti-counterfeiting method which can not be easily duplicated by people equipped with the same technical skills.

### SUMMARY OF THE INVENTION

This invention utilizing the uniqueness of ribonucleic acid sequences, after mixing ribonucleic acid with media, the media can be tagged onto or infiltrated into the authentic objects for anti-counterfeiting purpose. The authenticity of the objects can be verified by examining the existence and composition of ribonucleic acid.

A medium need to have the characteristics of being fully miscible with ribonucleic acid, and is not part of the objects being tagged. The composition of nucleic acid was designed to have specific length and sequence which can only be verified with certain PCR primers. For tagging process, the medium is first liquefied in a solvent, and quantified amount of known sequence ribonucleic acid is added to the medium and mixed well. The medium with ribonucleic acid is to be used to spread or fill objects. The medium solidifies after the evaporation of the solvent. For authenticity check, a small part of the medium is taken from the object and dissolved in a solvent; a solvent with high ribonucleic acid solubility is then added to extract ribonucleic acid. Centrifugation is used to separate the solvent with high ribonucleic concentration which can be used to perform PCR amplification procedure to examine the authenticity of the ribonucleic acid. Through this procedure, if the examined object carries the original ribonucleic acid, the PCR procedure will amplify extracted ribonucleic acid several million times with the same size and sequence of the original ribonucleic acid. On the other hand, if the examined object does not have the original ribonucleic acid, there will be no amplified ribonucleic acid product. Therefore, by comparing the size and amount of PCR products, the authenticity of labeled objects can be verified.

Since ribonucleic acid has sequence specificity, when performing PCR procedures only PCR primers with correct sequences can produce the original ribonucleic acid. In addition, the concentration of ribonucleic acid in the medium is very low which is extremely difficult to be decoded through cloning and transgenic methods, therefore warrants a very high security and specificity for anti-counterfeiting purposes.

### BRIEF DESCRIPTION OF DRAWINGS

FIG. 1. An 800 bp DNA fragment was tagged on the surface of object utilizing polycarbonate as the medium. DNA was recovered and amplified by PCR method, and stained with ethedium bromide after separated with gel electrophoresis.

FIG. 2. A 600 bp human WBC DNA fragment was tagged on the surface of object utilizing polycarbonate as the medium. DNA was recovered and amplified by PCR method, and stained with ethedium bromide after separated with gel electrophoresis.

### DETAILED DESCRIPTION

This invention utilizes the characteristics of ribonucleic acid which allow replication only when the sequences of two terminal ends are known. The invention is to preserve ribonucleic acid in a medium and then label objects with the medium. If the authenticity of the object is to be examined later on, it merely needs to examine the composition of the ribonucleic acid in the medium for authenticity check.

Ribonucleic acid is the general term for ribonucleic (RNA) acid and deoxyribonucleic acid (DNA). It can come from animal, plant, bacteria, fungus, virus et al., the so called organic organisms. But it can also be synthesized to form a vector or fragments. A unique characteristic of ribonucleic acid is that its specific sequence can be amplified with primers of specific sequences by PCR method. However, for PCR to work the prerequisite is that the terminal sequences of the ribonucleic acid fragment to be amplified is known in order to design primers with specific sequences for proper amplification.

The so-called medium is the intermediate used to encase ribonucleic acid and to attach to or mixed with objects. A good medium shall be able to mix well with ribonucleic acid, and can protect ribonucleic acid from deterioration. A medium also need to be moldable and has proper strength and can be attached to objects being labeled.

The so-called object is the items to be labeled. They can be liquid or solid; liquid such as lubricant oil, petroleum oil et al.; solid such as antiques, painting, jewelry, credit card and items with sentimental or real values can all be the object.

Method of labeling can be the spreading of medium on the surface of the object, such as credit card; can be the mixing of medium with the object such as water ink and oil paint; can be the filling of medium into the object such as seal. Various methods of labeling can be used depending on the essense of the objects.

### EXAMPLE 1

Utilization of 800 bp DNA and polycarbonate as medium to label a plastic film.

| | | |
|---|---|---|
| Materials: | Polycarbonate | Du Pont, Taiwan |
| | 95% ethanol | Taiwan Pharmaceuticals |
| | Acetone | Taiwan Merck UN1090 |
| | Chloroform | Taiwan Merck UN1888 |

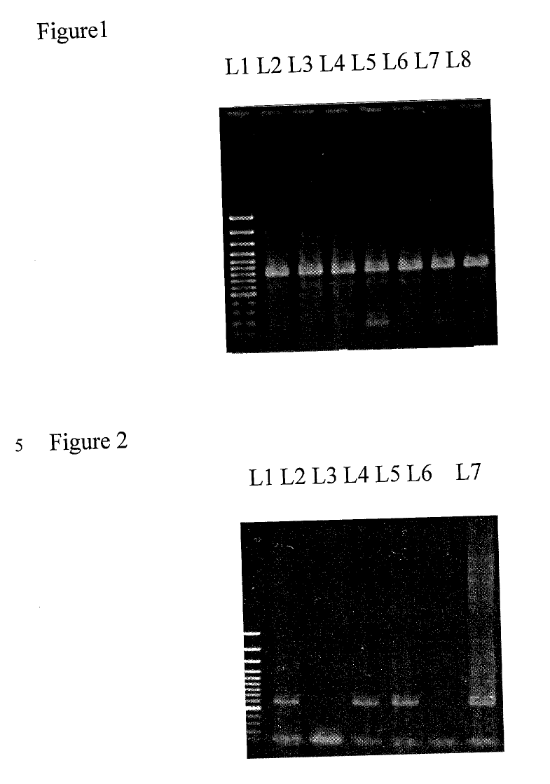

An 800 bp PCR synthesized DNA was dissolved in 70% ethanol and equal amount of acetone which was then mixed with polycarbonate/chloroform solution. The fully mixed solution was spread on plastic films and air-dried. After drying plastic films were placed in 4° C. fridge, in the dark, or exposed to sunlight for one day before recovery. For recovery, small pieces of plastic films were cut and dissolved with chloroform. A TE buffer was added, mixed well and centrifuged. Supernatants were used for PCR amplification. Products of PCR amplification were gel electrophoresis separated and stained. FIG. 1 shows the example of using polycarbonate and 800 bp DNA for labeling. From left to right, L1 is the 100 bp DNA ladder standard, L2 is from the dark treatment, L3, L4, and L5 are those exposed under sunlight treatment, L6, L7, and L8 are 4°C. fridge treatment. Results show that 800 bp DNA can be recovered from all treatments.

### EXAMPLE 2

Utilization of 600 bp human WBC DNA and polycarbonate as medium to label a plastic film.

| | | |
|---|---|---|
| Materials: | Polycarbonate | Du Pont, Taiwan |
| | 95% ethanol | Taiwan Pharmaceuticals |
| | Acetone | Taiwan Merck UN1090 |
| | Chloroform | Taiwan Merck UN1888 |

Human white blood cell DNA was extracted and dissolved in 70% ethanol and equal amount of acetone which was then mixed with polycarbonate/chloroform solution. The fully mixed solution was spread on plastic films and air-dried. After drying plastic films were placed in 4° C. fridge, in the dark, or exposed to sunlight for one day before recovery. For recovery, small pieces of plastic films were cut and dissolved with chloroform. A TE buffer was added, mixed well and centrifuged. Supernatants were used for PCR amplification. Products of PCR amplification were gel electrophoresis separated and stained. FIG. 2 shows the example of using polycarbonate and 600 bp human WBC DNA for labeling. From left to right, L1 is the 100 bp DNA ladder standard, L2 and L3 use 1 ul supernatant as the template, L4 and L5 use 2ul supernatant as the template, L6 is the negative control without DNA, L7 is human DNA positive control. Results show that human WBC DNA can be recovered from all treatments.

What is claimed is:

1. A method of utilizing ribonucleic acid as markers for product anti-counterfeit labeling and verification. The said method is to preserve ribonucleic acid in a medium and label the said medium onto or into objects for authenticity. The said medium can also be mixed directly with liquid or solid for labeling. For authenticity check, a recovery method with solvent and subsequent PCR amplification method is used to check the composition of the ribonucleic acid.

2. The method of claim 1 wherein said ribonucleic acid can be ribonucleic acid (RNA) or deoxyribonucleic acid (DNA).

3. The method of claim 1 wherein said ribonucleic acid can be animal, plant, bacterial, fungus, or virus origin or synthesized vector or fragments.

4. The method of claim 1 wherein said medium refers to materials inert and not deterious to the objects being labeled.

5. The method of claim 1 wherein said medium refers to polymers which are miscible with ribonucleic acid.

6. The method of claim 5 wherein said polymer can be acrylic or plastics.

7. The method of claim 1 wherein said liquid or solid can be ink, glue, or polymers.

8. The method of claim 7 wherein said liquid can be oil-based or water-based.

9. The method of claim 7 wherein said glue can be oil-based or water-based.

10. The method of claim 7 wherein said polymers can be acrylic or plastics.

11. The method of claim 1 wherein said recovery method refers to utilizing organic or inorganic solvent for extraction.

12. The method of claim 11 wherein said organic solvent can be buffer, benzene, characin, alcohol, acetone, or chloroform.

13. The method of claim 11 wherein said inorganic solvent can be water.

14. The method of claim 12 wherein said buffer can be phosphate-based buffer.

15. The method of claim 1 wherein said PCR method can be single or multiple nested PCR.
